(19) United States
(12) Patent Application Publication
(10) Pub. No.: US 2022/0130199 A1
(43) Pub. Date: Apr. 28, 2022

(54) MATRIX OF FLEXIBLE CAVITIES FOR DISPENSING OF INGREDIENTS

(71) Applicant: Mezli, Inc., San Mateo, CA (US)

(72) Inventors: Maxwell Emerald Perham, Palo Alto, CA (US); Alexander Makris Gruebele, Menlo Park, CA (US); Yuri Alexandrovich Kolchinski, San Francisco, CA (US)

(21) Appl. No.: 17/508,616

(22) Filed: Oct. 22, 2021

Related U.S. Application Data
(60) Provisional application No. 63/104,470, filed on Oct. 22, 2020.

(51) Int. Cl. G07F 11/16; G07F 17/00; G07F 11/62; G07F 9/10

(52) U.S. Cl. CPC G07F 11/165; G07F 9/105; G07F 11/62; G07F 17/0064

(57) ABSTRACT

A system for dispensing food is described. The system has one or more cavities that are configured to hold food items. Each cavity has an opening and a movable wall opposite the opening. The cavities are supported by a support matrix that holds each cavity at a specified location. A punch with an actuation system is configured to align with a cavity at a specified location and extend to compress the cavity wall to dispense the food item in the cavity. A controller of the system receives instructions comprising a food item order. The controller determines the location of a cavity holding the ordered food item and transmits those instructions to the actuation mechanism so that the actuation mechanism aligns the punch with the cavity and extends the punch to dispense the food item.

### CROSS-REFERENCE TO RELATED APPLICATIONS

This application claims the benefit of U.S. Provisional Application No. 63/104,470 filed Oct. 22, 2020, which is incorporated by reference in its entirety.

### FIELD OF ART

This disclosure relates generally to automated food preparation systems, and more specifically to storage and dispensing systems for automated food preparation systems.

### BACKGROUND

Automated food preparation faces several challenges in its development, a few of which being portioning, contamination, and food storage. Controlled portioning is difficult to achieve without prohibitively expensive equipment, and even with this equipment there may be little ability for a customer to customize their portion size. Cross contamination between food items may occur as a function of the same parts of an automated system being used to handle multiple different types of food items. The risk of contamination may decrease the potential customer base of automated food preparation systems by excluding those with food allergies or sensitivities. Finally, food storage also poses a challenge because the variety of ingredients needed for automated food preparation may need to be stored at different conditions. For example, fruits may best be stored freeze dried while meats may be stored frozen and grains are stored uncooked. Each of these items must be stored in an environment with the correct environmental controls such as temperature and humidity to keep the food items fresh. As such, the combination of these problems creates the need for a safe, and efficient system of storing and portioning food items for automated preparation while avoiding contamination.

### SUMMARY

The system described within is configured to perform food storage and portioned dispensing. The system may be housed within an automated food preparation system referred to as the auto-kitchen or vending machine herein. The system may interact with one ore more other systems of the auto-kitchen to cook, sauce, rehydrate, or perform other food preparation activities on the food item.

The system includes one or more cavities wherein each cavity stores a food item or a portion of a food item. The cavities may, for example take on the shape of a rectangular prism. Each cavity has an opening through which the food item may be dispensed and a wall opposite that opening that is configured to move toward the opening when force is applied to it. The cavities are supported by a matrix that is configured to hold each of the one or more cavities at a specified location within the matrix. The system additionally includes a punch with an actuation system that can translate the punch to a specified location and extend and retract the punch. A controller communicates with several components of the system. The controller receives instructions including a food item ordered by a user of the system. The controller determines the specified location of the cavity within the support matrix in which the ordered food item is held. The punch is instructed by the controller to translate via the actuation mechanism to the specified location of the cavity within the support matrix and extend the punch at the specified location. Extending the punch compresses the wall of the cavity holding the ordered food item and causes the food item to be dispensed from the opening of the cavity.

Potential examples of end use cases for this dispenser unit include use in the back of house of a restaurant, customer facing in a dining hall or buffet setting, and in an automated vending capacity which is the use case discussed at length herein.

### BRIEF DESCRIPTION OF THE DRAWINGS

FIG. 1 illustrates the system in accordance with one or more embodiments.

FIG. 2 is a flowchart representing a method performed by the system in accordance with one or more embodiments.

FIG. 3 illustrates components and assembly of the system in accordance with one or more embodiments.

FIG. 4 illustrates a method of filling the cavities of the system in accordance with one or more embodiments.

FIG. 5 illustrates an embodiment of the cavities in which an opening of each cavity is cover by a nozzle sheet.

FIG. 6 illustrates additional components of the cavities may be attached to for dispensing in accordance with one or more embodiments.

FIG. 7 illustrates an embodiment of the system in which the assemblies are actuated in accordance with one or more embodiments.

FIG. 8 illustrates embodiments of the punch and nozzle in accordance with one or more embodiments.

FIG. 9 is a block diagram of a computing system in accordance with one or more embodiments.

The figures depict various embodiments for purposes of illustration only. One skilled in the art will readily recognize from the following discussion that alternative embodiments of the structures and methods illustrated herein may be employed without departing from the principles described herein.

### DETAILED DESCRIPTION

The described system for dispensing food may be housed in an automated food preparation system for single serving food items. The system may also be a series of appliances in a kitchen. One object of embodiments described herein is to enable accurate pre-portioning and dispensing of food for the purpose of automating the creation of made-to-order dishes. Potential examples of end use cases for this dispenser unit include use in the back of house of a restaurant, customer facing in a dining hall or buffet setting, and in an automated vending capacity which is the use case discussed at length herein.

In an embodiment of a vending machine-like use case, a customer orders a dish including one or more food items one or more of the dispensing systems held inside the vending machine. The machine and dispenses materials from holding cavities into a serving unit such as a plate or bowl to fulfill the customer's order. The machine can also be configured to dispense ingredients directly onto a food item such as by dispensing sauce and cheese onto a pizza crust or hummus and vegetables onto a pita. In some embodiments the plate or bowl may be edible such as a taco bowl or tortillas. The machine may further heat or chill the food items and add additional sauces and spices based on the customer's order.

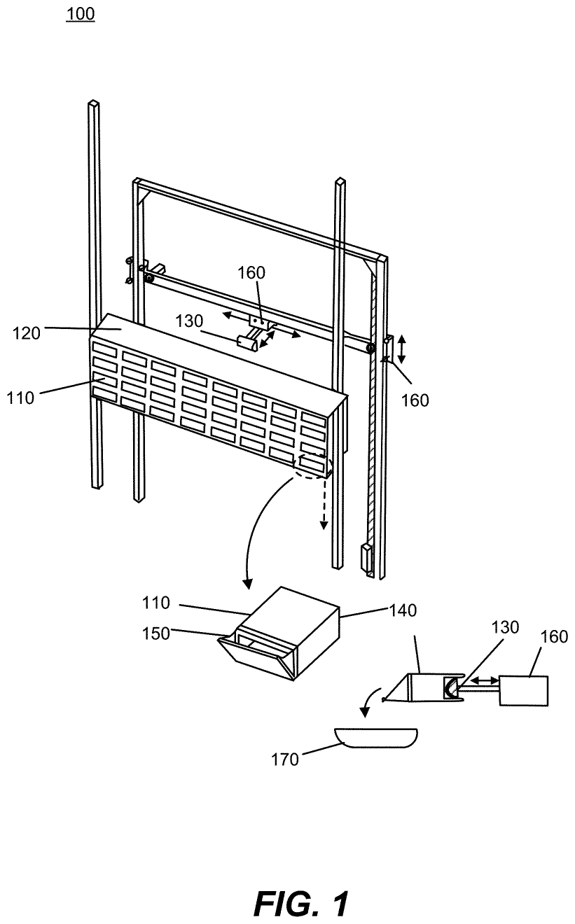

FIG. 1 illustrates the system in accordance with one or more embodiments. The system comprises several cavities 110 held in place by a support matrix 120. The cavities 110 each hold a food item, and when the food item is ordered by a user of the system, the system actuates the punch 130 to the location of the cavity holding the food item and extends the punch to compress a wall 140 of the cavity 110. Each cavity is configured with a wall 140 opposite an opening 150 such that when the wall is compressed, the wall moves toward the opening and pushes the food item out of the opening. The cavities 110 as shown in FIG. 1 are rectangular prisms, however, in other embodiments, the cavities 110 may take the form of tubes, bags, or other shapes having an opening on one side opposite a compressible wall. In some embodiments, the cavities 110 are made of flexible material such as silicone or other elastomers so that the compression by the punch 130 causes the cavity to invert and push out the food item. In other embodiments, the cavities 110 may be made of rigid material with a wall 140 opposite the opening 150 that is configured to move toward the opening in response to the force of the punch 130. The wall, for example, may move on tracks toward the opening and be spring loaded so that the wall 140 returns to its original position when not compressed by the punch 130. In another example, compressive force on the wall 140 by the punch 130 may cause the cavity 110 to collapse into itself similarly to a collapsible silicone cup. In some embodiments, the multiple cavities 110 may be part of a single piece of material. For example, a sheet of silicone can be molded or extruded to have a matrix pattern of multiple cavities. In other embodiments, the cavities 110 are each separate and can be individually filled and replaced. In some embodiments, each cavity 110 is an isolated temperature-controlled zone.

The support matrix 120 is a grid having a spot for supporting each cavity. The matrix, in some embodiments, has a number of columns and rows to corresponding to the arrangement of the cavities 110. The support matrix 120 is made of a material that is more rigid than that of the cavities 110. For example, the matrix 120 may be made of rigid plastic or an elastomer having a higher spring constant than the material of the cavities 110. The matrix 120 allows for the cavities 110 to stay in place while the punch 130 dispenses food items from them. The matrix 120 can be used to keep ingredients hot or cold while in storage. Temperature control of the matrix could be an active subsystem with one or both of a heating or cooling system and/or a passive insulated system. In some embodiments, the matrix 120 may have hinges or be otherwise configured to fold for ease of storage when empty.

The punch 130 is moved by an actuation mechanism 160. The punch 130 may move in the x and y directions to navigate to the specified location of a cavity 110 holding the ordered food item. The actuation mechanism 160 may include a system of motors moving cables along pulleys similar to an elevator mechanism, a hydraulic mechanism, a two-axis belt mechanism, or other forms of single or double axis translation. The actuation mechanism 160 is further responsible for extending and retracting the punch 130 once the punch is at the specified location in the matrix 120. The actuation mechanism 160 may extend and retract the punch 130 using hydraulic, mechanical, or compressed air force. In some embodiments the punch 130 may be telescopic and expand responsive to the actuation mechanism, whereas in other embodiments the punch 130 may have a fixed length.

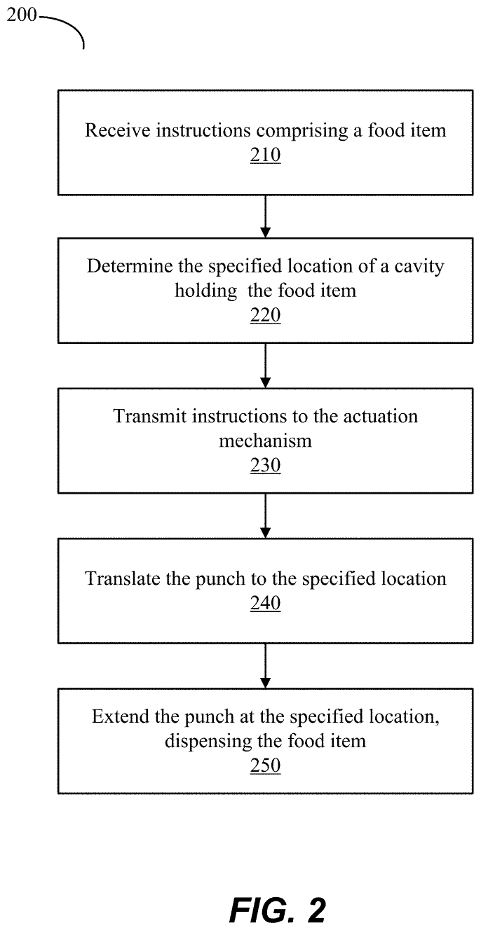

The punch 130 can be used to dispense any proportion of the content of the cavity from 0 to 100% into a serving dish 170. The punch 130 itself may have heating or cooling options and dimensional tolerances such that the punch ensures the correct portion of the cavity 110 is emptied upon command. This enables dispensing of precise amounts of food. This punch 130 could be screw driven, spring driven, pneumatic, hydraulic, etc. Retraction of the punch 130 from a cavity 110 drives retraction of the wall 140 of the cavity through variety of potential means including but not limited to latching features, magnets, hook and loop, and/or permanent or temporary adhesives. The movements of the punch 130 by the actuation mechanism 160 are controlled by a controller not shown here. The controller is discussed further with reference to FIG. 2.

A shown here the matrix 120 of cavities 110 is held horizontally but it may be canted at an angle. The wall 140 of an individual cavity 110 is pressed to force the contents of that cavity to come out of the opening 150. The opening may include a passive or active element used to seal the opening of the cavity. The cavities 110 can be of any size and be put into a support matrix 120 of a corresponding size. They can also have heating or cooling units, insulation, and sensor packages embedded into their material.

FIG. 2 is a flowchart representing a method performed by the system in accordance with one or more embodiments. The method 200 includes receiving instructions indicating a food item, determining the specified location of a cavity holding the food item, and transmitting instructions to the actuation mechanism causing the actuation mechanism to translate the punch to the specified location and extend the punch to dispense the food item. The steps of the method 200 are performed by a controller. The controller may include a computer processor capable of reading program code. The controller may be programed to perform the steps of method 200 as well as other methods. The controller may be physical attached to the system for dispensing food and electronically coupled to the components of the system, or the controller may be separate from the system and be in wireless communication with the components of the system.

The controller receives 210 instructions including a food item. The instructions may originate from data of an order placed by a user for a meal to be prepared. A user of the system may place their order, for example, via a user interface of a vending machine housing the system or via a client device such as a smart phone that is in wireless communication with the system. The instructions include at least a selection of a food item. In some embodiments, the instructions may further include a flavor preference, food allergies, method of cooking the food item, additional food items, sauces, side dishes, or a combination thereof.

The controller determines 220 the specified location of the cavity that is holding the food item. Each cavity may have a coordinate assigned to it corresponding to the row and column of the support matrix that the cavity is in. The coordinate may be the specified location of the cavity. In other embodiments the specified location may be represented by a number or letter associated with the cavity's position or by x and y distances that the actuation mechanism moves the punch.

The controller transmits 230 instructions to the actuation mechanism. The instructions include translating 240 to the specified location and extending 250 the punch 130 into the support matrix at the specified location. The instructions activate the actuation mechanism 160 of the punch 130 to move the punch. The translation instruction may include a distance the punch travels along the x and/or y axis to reach the specified location. The punch extension instruction may include a distance or depth that the punch should extend into the matrix to compress the cavity 110. For example, if a user orders half of a portion of a food item, the instructions sent by the controller to the actuation mechanism, may instruct the actuation mechanism to only extend the punch halfway into the cavity to only dispense half of the portion in the cavity. The instructions may further indicate for the punch to retract from the support matrix after it has reached the instructed extension.

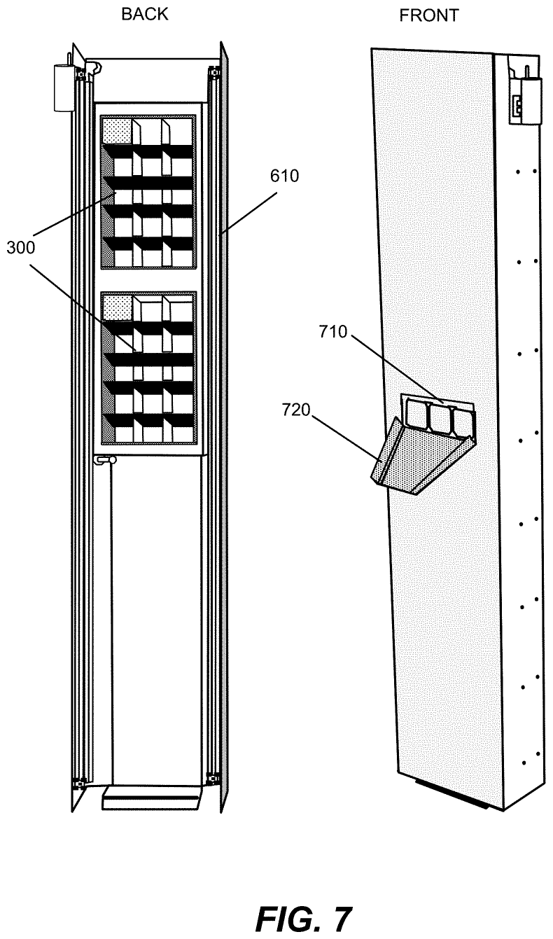

In some embodiments, rather than translating 240 the punch 130 to the cavity 110, the support matrix 120 is actuated to align the correct cavity with the punch 130 so that the punch can then extend 250 and dispense the food item from the cavity. In other embodiments both the punch and the support matrix are actuated. In those embodiments the punch may be configured to move along the x axis while the support matrix 120 moves along the y axis to align the punch 130 with the correct cavity 110. The opposite may be true, with the punch moving along the y and matrix moving along the x, depending on the embodiment. Embodiments in which the matrix 120 is translated are further discussed with reference to FIG. 7.

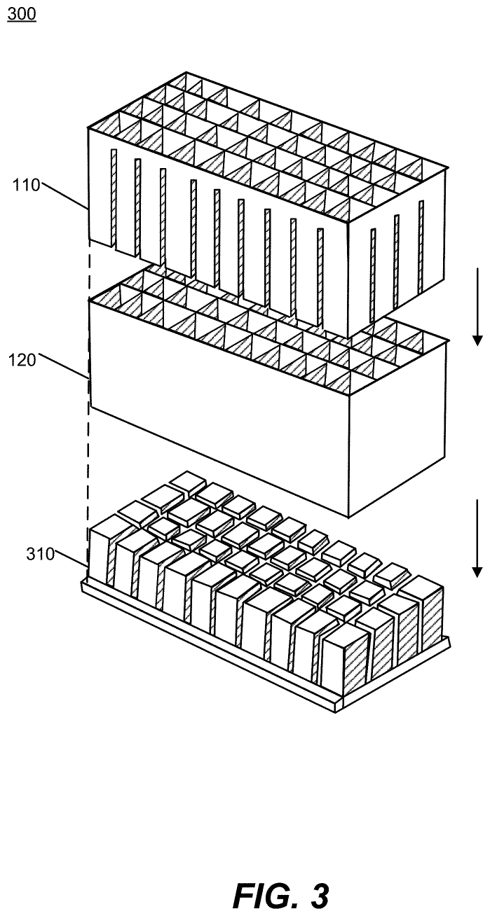

FIG. 3 illustrates components and assembly of the system in accordance with one or more embodiments. Before the system is prepared for dispensing food, the cavities 110 and support matrix 120 are assembled. In some embodiments, the assembly 300 additionally includes a portion control unit 310. In the embodiment shown in FIG. 3, the cavities 110 are a single piece of flexible material having columns and rows of cavities. To prepare for dispensing, the matrix of cavities 110 is coupled to a support matrix 120 having a shape that corresponds to the matrix of cavities 110. One the cavities 110 are coupled to the support matrix 120 each cavity is supported by the more rigid material of the matrix 120. In other embodiments not shown in FIG. 3 the cavities 110 are individual pieces rather than a single sheet and may be rigid or flexible. In those embodiments, the support matrix 120 takes a different form to support the cavities 110 and may have additional coupling mechanisms like clips or latches.

In some situations, it may be preferable to fill the cavities 110 less than 100% full such as to allow for dispensing of kid-sized portions. In those situations, the portion control unit 310 can additionally be coupled to the matrix 120 and cavities 110 assembly. The portion control unit 310 is the inverse of the shape of the cavities 110. For example, if the cavities 110 are 3 columns and 5 rows of 15 cavities with a base of roughly 2 centimeters (cm) by 2 cm and a depth of 10 cm, the portion control unit 310 is a 3 by 5 matrix of 15 protrusions having a roughly 2 cm by 2 cm base. The length of the protrusions is determined by the desired portion size held in the cavities. In addition, it is noted that measurements herein may be approximate (or substantially) relative to the measurement unit noted.

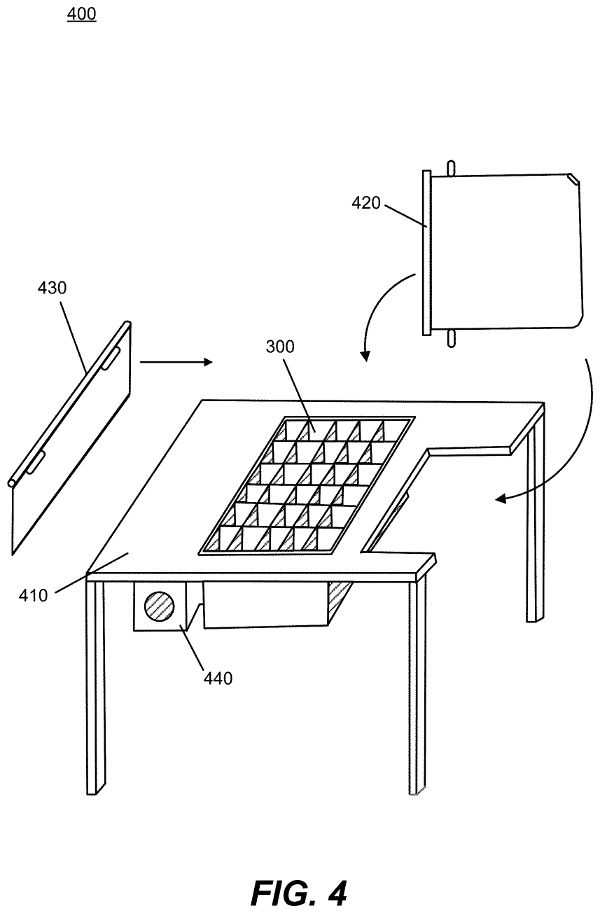

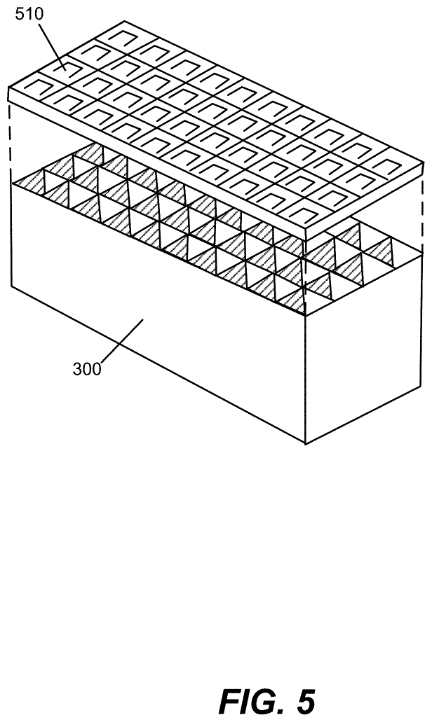

The portion control unit 310 decreases the available room in the cavities by partially compressing the wall 140 opposite the opening 150 and moving the wall toward the opening. The compression of the wall 140 by the portion control unit 310 protrusions may partially invert the cavity 110 to decrease the available volume of the cavity. If the cavities have a depth of 10 cm and the desired portion is 50% of the volume of the cavity, then the portion control unit 310 protrusions will have a length of 5 cm and collapse the cavities by 5 cm to reduce the volume by half If the desired portion is 75% of the volume of the cavity 110, then the protrusions will only be 2.5 cm long. The portion control unit 310 is only coupled to the assembly 300 of the cavities 110 and the support matrix 120 during the filling of the cavities 110 which is discussed further in reference to FIG. 4. The portion control unit 310 is then removed from the assembly, allowing the food items to settle into the full volume of the cavities 110. In some embodiments, after the cavities 110 are filled, a lid or nozzle sheet is attached to the side of the assembly having the openings of the cavities. The lid or nozzle sheet prevents food items from falling out of the cavities before dispensing and is further discussed with reference to FIG. 5.

FIG. 4 illustrates a method 400 of filling the system in accordance with one or more embodiments. The assembly 300 of the cavities 110 and support matrix 120 (optionally including the portion control unit 310) discussed above is filled, in some embodiments, by inserting the assembly 300 to a compartment in a table 410. The large volume of the food item to be held in the cavities 110 is poured over the surface of the table 410 from a storage vessel 420. The food items may fall into the assembly 300 or be pushed in by a scraper 430. In some embodiments, the table 410 is equipped with a vibration mechanism 440. The vibration mechanism 440, when active, vibrates the table and the cavity-matrix assembly 300 to shake the food item into the cavities 110 and avoid having unused space. This method ensures that each cavity is filled with an even amount and that no cavity is underfilled due to clumping or blockage of the food item.

In an example in which the food item to be held in the cavities is rice, individually frozen grains of rice may be poured over the table 410. This step may be performed by a human operator or by robotic machinery. The grains of rice fall into the cavities 110, but some may stay on the table 410. To push the grain on the table 410 into the cavities 110 a scraper 420 is used. The vibration mechanism 440 is then activated which increases the packing efficiency of the grains of rice. The scraper 420 may then be used again to level off any overfilled cavities. The steps of vibration and scraping may be repeated to ensure completely filled and even cavities of rice.

The above-described method 400 of filling the cavities allows for labor savings and cost reduction because the cavities are pre-portioned, and many cavities can be filled at once. This process can be driven by hand or by machine and is a scalable process that can be grown to accommodate an arbitrary number of cavities.

In some embodiments, the cavities are filled using a different method such as measuring a scoop of a food item and depositing it into each cavity, however these other methods may be less efficient and result in uneven portioning.

FIG. 5 illustrates an embodiment of the assembly 300 in which an opening of each cavity is covered by a nozzle sheet 510. Once the cavity-matrix assembly 310 is filled with portions of the food item, the assembly may be covered with a nozzle sheet. The nozzle sheet 510 is a sheet having multiple nozzles, the nozzles arranged to align with the cavities 110 of the assembly 300. A nozzle 510 sheet can be attached to the assembly on the side of the cavity openings. The nozzle sheet 510 provides a method of more accurately delivering the food item into a serving dish. Each cavity 110 may have its own nozzle such as a slide, tube, or grate that directs the food item in the cavity into the serving dish. In some embodiments, the nozzles of the nozzle sheet 510 are made up of a perforated sheet of flexible material having perforations or slits at each cavity, as seen in the embodiment of FIG. 5. The slits or perforations can be configured to act similarly to a dog door and will open when the food item pushes against them but may hermetically seal the cavities 110 before pushed open.

In some embodiments, the assembly 300 if further covered with a lid (not shown). The lid may lock all of the contents in place for transportation of the assembly 300 and nozzle sheet 510. The lid is removably coupled to the assembly 300 over the nozzle sheet 510. The lid may be attached, for example, with latches, clips, hooks, or tension springs. The lid has a flat surface to enable multiple assemblies 300 to be stacked for transportation.

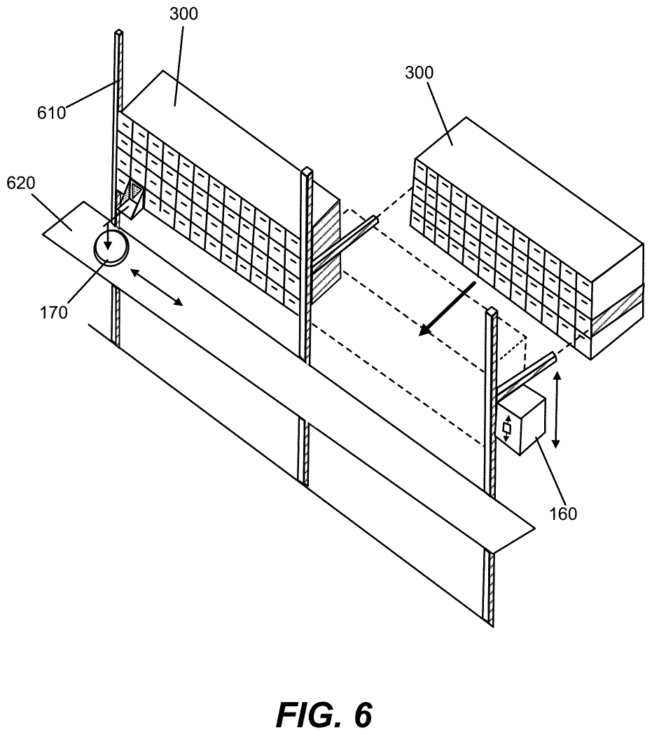

FIG. 6 illustrates additional components of the cavities may be attached to for dispensing in accordance with one or more embodiments. Once the cavities 110 are filled and covered with a nozzle sheet, the cavities are attached to a dispensing scaffold 610. The dispensing scaffold 610 holds one or more cavity assemblies 300 in place. The scaffold.610 positions the assemblies 300 above a conveyor belt 620 on which serving dishes 170 travel. The scaffold 610 additionally supports the punch 130 (not shown here) and the actuation mechanism 160. In some embodiments, the actuation mechanism 160 can move the cavity assembly 300 up or down the scaffold 610. Moving the cavity assembly 300 down the scaffold 610 ensures that the food items are dispensed from the same height regardless of the row or column the cavity is located, this avoids splashing and spilling. The movement of the assembly by the actuation mechanism 160 can occur through a variety of techniques, e.g., using hydraulics, lead screw, cam, cables and pulleys, etc. In some embodiments, the serving dish 170 may be moved under the cavity from which a food item is being dispensed by the punch.

FIG. 7 illustrates an embodiment of the food dispensing system in which the cavities are actuated, in accordance with one or more embodiments. The embodiment shown in FIG. 7 empties the cavities 110 from the bottom row and then shifts the cavity assemblies 300 down so that the next row aligns with the dispensing region 710. The dispensing region 710 is a window that exposes a single row of cavities of the assembly 300. The dispensing region has a slide 720 attached. When dispensed by the punch 160, the food items move down the slide 720 and into a serving dish 170. In some embodiments, the slide 720 obviates the nozzle sheet 510 as the slide directs the food items to the proper place in the serving dish 170, as such, when the slide 720 is present, the nozzle sheet 510 may not be. The length of the slide may depend on the embodiment. For example, a slide of one food dispensing system may dispense food items into the far side of the dish 170 using a long slide, while a second dispensing system may dispense food items into the near side of the dish 170 using a short slide 720. The assemblies may be moved down the scaffold 610 via an actuation mechanism 160 including a cable and weight system. Other modes of actuation down the scaffold 610 are also possible. Once the assemblies 300 reach the bottom of the scaffold 610 an indicator may be activated to indicate to an operator of the system that the cavities need to be refilled.

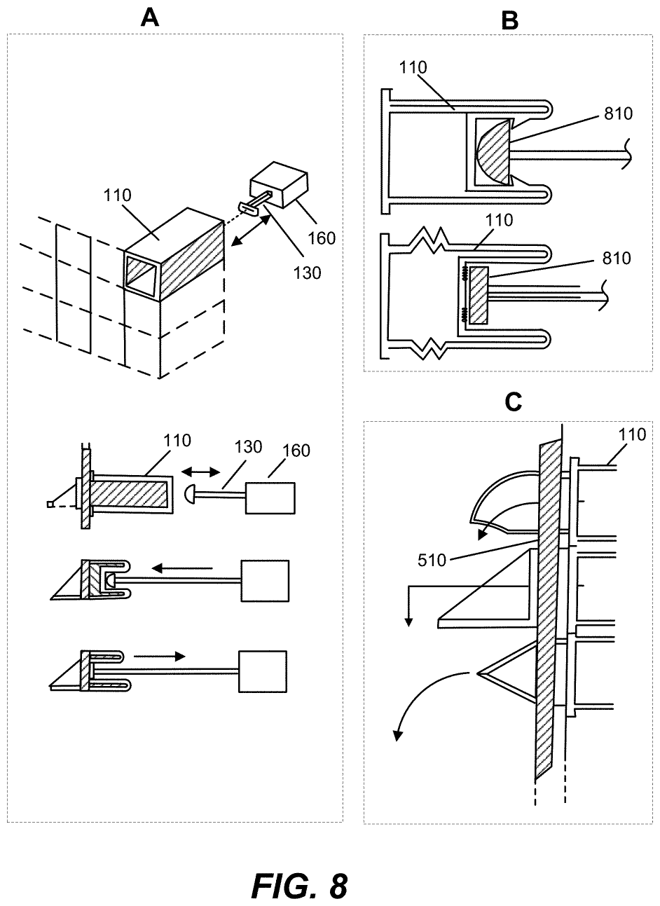

FIG. 8 illustrates embodiments of the punch 130 and nozzle of the nozzle sheet 510 in accordance with one or more embodiments. Portion A of FIG. 8 illustrates a variety of punch 130 embodiments. In some embodiments, portion control may be done by extending the punch 130 such that it only compresses the cavity 110 partially. The punch 130 is shown at varying degrees of extension for the mode of portion control. The varying degrees of extension result in a varying amount of inversion of the cavity 110.

As seen in portion B of FIG. 8, the punch 130 may have a head 810 that contacts the compressible wall of the cavity. The head may be round, flat, or angled. The shape of the head 810 may be chosen based on the type of food item being dispensed or the type of cavity. There are many additional changes that can be made to the punch 130, including localized sensors, magnets for retraction, heating and cooling zones, and internal features such as blades or filters/sieves. Sensors of the punch 130 may be configured to detect characteristics of the food item in the cavity 110 such as moisture content, portion size, or temperature. In some embodiments, the punch is enabled to pull the cavity back to its original shape after compressing it.

Portion C of FIG. 8 further details embodiments of nozzles of the nozzle sheet 510. The nozzle sheet 510 discussed with reference to FIG. 5 is made up of a plurality of nozzles configured to align with the openings of the cavities 110. Nozzles on the same nozzle sheet 510 may have different forms or all have the same form. The nozzle designs prevent dripping or clinging of the food item held in the matrix of flexible cavities. The nozzles can have additional features such as sieves, filters, internal blades, etc. The nozzles can be active or passive elements or contain active elements and sensors in their internal structure. Particular nozzle shapes may be chosen for the desired final presentation of the ingredients within the delivery unit or for the optimal setup for future steps. The nozzles could be active or passive elements and/or contain active elements and/or sensors in their internal structure. For example, embedded sensors could be used to detect the water content of the passing ingredients, their temperature, the ambient temperature, and pressure of the machine internals, etc.

### Example Computing Machine

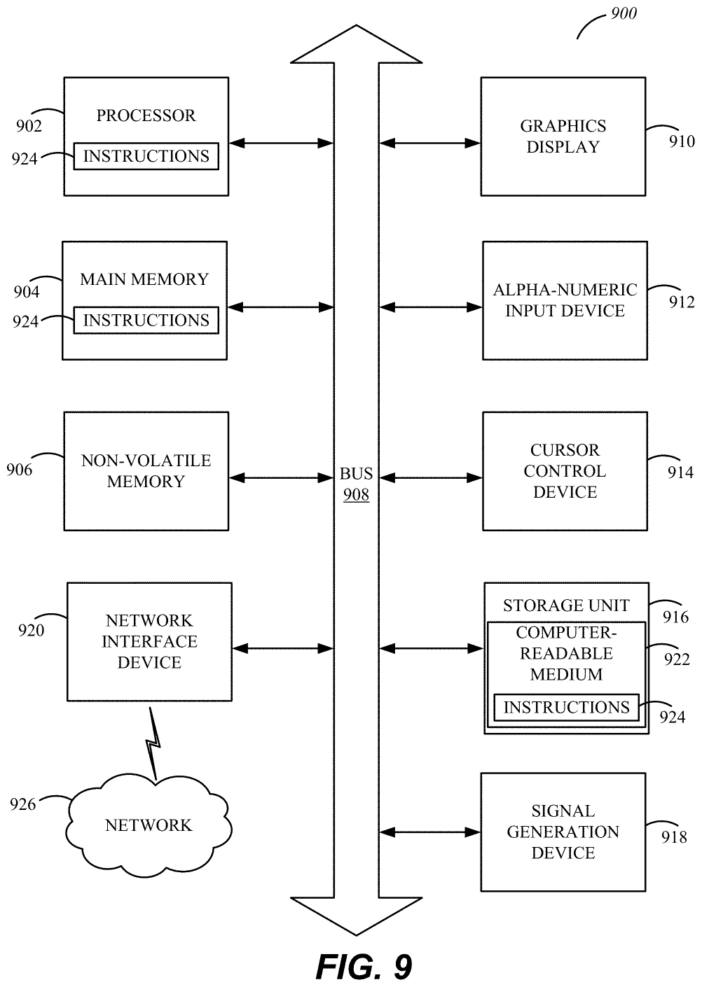

FIG. 9 is a block diagram illustrating an example architecture of a computing device, in accordance with some embodiments. The computing device described herein may be configured to specifically execute, for example, the controller described in FIGS. 1 and 2. For example, the computing device processes all necessary instructions for the method 200 to be completed. The computing device (or computer) is capable of reading instructions from a computer-readable medium and executing them in a processor (or controller). A computer described herein may include a single computing machine shown in FIG. 9, a virtual machine, a distributed computing system that includes multiples nodes of computing machines shown in FIG. 9, or any other suitable arrangement of computing devices.

By way of example, FIG. 9 shows a diagrammatic representation of a computing machine in the example form of a computer system 900 within which instructions 924 (e.g., software, program code, or machine code), which may be stored in a computer-readable medium for causing the machine to perform any one or more of the processes discussed herein may be executed. In some embodiments, the computing machine operates as a standalone device or may be connected (e.g., networked) to other machines. In a networked deployment, the machine may operate in the capacity of a server machine or a client machine in a server-client network environment, or as a peer machine in a peer-to-peer (or distributed) network environment.

The structure of a computing machine described in FIG. 9 may correspond to any software, hardware, or combined components shown in FIG. 1, including but not limited to, the user device 111, the computing server 90, and various engines, modules, interfaces, terminals, computing nodes and machines. While FIG. 9 shows various hardware and software elements, each of the components described in FIG. 1 may include additional or fewer elements.

By way of example, a computing machine may be a personal computer (PC), a tablet PC, smartphone, a web appliance, a network router, an internet of things (IoT) device, a switch or bridge, or any machine capable of executing instructions 924 that specify actions to be taken by that machine. Further, while only a single machine is illustrated, the term “machine” and “computer” may also be taken to include any collection of machines that individually or jointly execute instructions 924 to perform any one or more of the methodologies discussed herein.

The example computer system 900 includes one or more processors 902 such as a CPU (central processing unit), a GPU (graphics processing unit), a TPU (tensor processing unit), a DSP (digital signal processor), a system on a chip (SOC), a controller, a state equipment, an application-specific integrated circuit (ASIC), a field-programmable gate array (FPGA), or any combination of these. Parts of the computing system 900 may also include a memory 904 that store computer code including instructions 924 that may cause the processors 902 to perform certain actions when the instructions are executed, directly or indirectly by the processors 902. Instructions can be any directions, commands, or orders that may be stored in different forms, such as equipment-readable instructions, programming instructions including source code, and other communication signals and orders. Instructions may be used in a general sense and are not limited to machine-readable codes. The processors 902 may include one or more multiply-accumulate units (MAC units) that are used to perform computations of one or more processes described herein.

One and more methods described herein improve the operation speed of the processors 902 and reduces the space required for the memory 904. For example, the various processes described herein reduce the complexity of the computation of the processors 902 by applying one or more novel techniques that simplify the steps in analyzing data and generating results of the processors 902. The algorithms described herein also reduces the size of the models and datasets to reduce the storage space requirement for memory 904.

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations. Even though in the specification or the claims may refer some processes to be performed by a processor, this should be construed to include a joint operation of multiple distributed processors.

The computer system 900 may include a main memory 904, and a static memory 906, which are configured to communicate with each other via a bus 908. The computer system 900 may further include a graphics display unit 910 (e.g., a plasma display panel (PDP), a liquid crystal display (LCD), a projector, or a cathode ray tube (CRT)). The graphics display unit 910, controlled by the processors 902, displays a graphical user interface (GUI) to display one or more results and data generated by the processes described herein. The computer system 900 may also include alphanumeric input device 912 (e.g., a keyboard), a cursor control device 914 (e.g., a mouse, a trackball, a joystick, a motion sensor, or other pointing instrument), a storage unit 916 (a hard drive, a solid state drive, a hybrid drive, a memory disk, etc.), a signal generation device 918 (e.g., a speaker), and a network interface device 920, which also are configured to communicate via the bus 908.

The storage unit 916 includes a computer-readable medium 922 on which is stored instructions 924 embodying any one or more of the methodologies or functions described herein. The instructions 924 may also reside, completely or at least partially, within the main memory 904 or within the processor 902 (e.g., within a processor's cache memory) during execution thereof by the computer system 900, the main memory 904 and the processor 902 also constituting computer-readable media. The instructions 924 may be transmitted or received over a network 926 via the network interface device 920.

While computer-readable medium 922 is shown in an example embodiment to be a single medium, the term “computer-readable medium” should be taken to include a single medium or multiple media (e.g., a centralized or distributed database, or associated caches and servers) able to store instructions (e.g., instructions 924). The computer-readable medium may include any medium that is capable of storing instructions (e.g., instructions 924) for execution by the processors (e.g., processors 902) and that causes the processors to perform any one or more of the methodologies disclosed herein. The computer-readable medium may include, but not be limited to, data repositories in the form of solid-state memories, optical media, and magnetic media. The computer-readable medium does not include a transitory medium such as a propagating signal or a carrier wave.

In various embodiments, a non-transitory computer readable medium that is configured to store instructions may be used. The instructions, when executed by one or more processors, cause the one or more processors to perform steps described in the above computer-implemented processes or described in any embodiments of this disclosure. In various embodiments, a system may include one or more processors and a storage medium that is configured to store instructions. The instructions, when executed by one or more processors, cause the one or more processors to perform steps described in the above computer-implemented processes or described in any embodiments of this disclosure.

### Additional Considerations

The disclosed configuration describes examples systems (and methods and computer program code) beneficially configured to improve capabilities of autonomous single-serving food preparation. For example, the method within allows for accurate control of portion sizing while reducing risk of cross-contamination of food items. Storing each portion separately in a cavity keeps the food items fresh and easily portion-controlled. Further, the system and method allow for the cavities to be quickly and easily refillable as discussed in reference to FIG. 4.

Reference in the specification to “one embodiment” or to “an embodiment” means that a particular feature, structure, or characteristic described in connection with the embodiments is included in at least one embodiment. The appearances of the phrase “in one embodiment” or “an embodiment” in various places in the specification are not necessarily all referring to the same embodiment.

Some portions of the detailed description are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps (instructions) leading to a desired result. The steps are those requiring physical manipulations of physical quantities. Usually, though not necessarily, these quantities take the form of electrical, magnetic or optical signals capable of being stored, transferred, combined, compared and otherwise manipulated. It is convenient at times, principally for reasons of common usage, to refer to these signals as bits, values, elements, symbols, characters, terms, numbers, or the like. Furthermore, it is also convenient at times, to refer to certain arrangements of steps requiring physical manipulations or transformation of physical quantities or representations of physical quantities as modules or code devices, without loss of generality.

However, all of these and similar terms are to be associated with the appropriate physical quantities and are merely convenient labels applied to these quantities. Unless specifically stated otherwise as apparent from the following discussion, it is appreciated that throughout the description, discussions utilizing terms such as “processing” or “computing” or “calculating” or “determining” or “displaying” or “determining” or the like, refer to the action and processes of a computer system, or similar electronic computing device (such as a specific computing machine), that manipulates and transforms data represented as physical (electronic) quantities within the computer system memories or registers or other such information storage, transmission or display devices.

Certain aspects of the embodiments include process steps and instructions described herein in the form of an algorithm. It should be noted that the process steps and instructions of the embodiments can be embodied in software, firmware or hardware, and when embodied in software, could be downloaded to reside on and be operated from different platforms used by a variety of operating systems. The embodiments can also be in a computer program product which can be executed on a computing system.

The embodiments also relate to an apparatus for performing the operations herein. This apparatus may be specially constructed for the purposes, e.g., a specific computer, or it may comprise a computer selectively activated or reconfigured by a computer program stored in the computer. Such a computer program may be stored in a computer readable storage medium, such as, but is not limited to, any type of disk including floppy disks, optical disks, CD-ROMs, magnetic-optical disks, read-only memories (ROMs), random access memories (RAMs), EPROMs, EEPROMs, magnetic or optical cards, application specific integrated circuits (ASICs), or any type of media suitable for storing electronic instructions, and each coupled to a computer system bus. Memory can include any of the above and/or other devices that can store information/data/programs and can be transient or non-transient medium, where a non-transient or non-transitory medium can include memory/storage that stores information for more than a minimal duration. Furthermore, the computers referred to in the specification may include a single processor or may be architectures employing multiple processor designs for increased computing capability.

The algorithms and displays presented herein are not inherently related to any particular computer or other apparatus. Various systems may also be used with programs in accordance with the teachings herein, or it may prove convenient to construct more specialized apparatus to perform the method steps. The structure for a variety of these systems will appear from the description herein. In addition, the embodiments are not described with reference to any particular programming language. It will be appreciated that a variety of programming languages may be used to implement the teachings of the embodiments as described herein, and any references herein to specific languages are provided for disclosure of enablement and best mode.

Throughout this specification, some embodiments have used the expression “coupled” along with its derivatives. The term “coupled” as used herein is not necessarily limited to two or more elements being in direct physical or electrical contact. Rather, the term “coupled” may also encompass two or more elements are not in direct contact with each other, but yet still co-operate or interact with each other, or are structured to provide a thermal conduction path between the elements.

Likewise, as used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus.

In addition, use of the “a” or “an” are employed to describe elements and components of the embodiments herein. This is done merely for convenience and to give a general sense of embodiments. This description should be read to include one or at least one and the singular also includes the plural unless it is obvious that it is meant otherwise. The use of the term and/or is intended to mean any of: “both”, “and”, or “or.”

In addition, the language used in the specification has been principally selected for readability and instructional purposes, and may not have been selected to delineate or circumscribe the inventive subject matter. Accordingly, the disclosure of the embodiments is intended to be illustrative, but not limiting, of the scope of the embodiments.

While particular embodiments and applications have been illustrated and described herein, it is to be understood that the embodiments are not limited to the precise construction and components disclosed herein and that various modifications, changes, and variations may be made in the arrangement, operation, and details of the methods and apparatuses of the embodiments without departing from the spirit and scope of the embodiments.

The foregoing description of the embodiments has been presented for illustration; it is not intended to be exhaustive or to limit the patent rights to the precise forms disclosed. Persons skilled in the relevant art can appreciate that many modifications and variations are possible considering the above disclosure.

Finally, the language used in the specification has been principally selected for readability and instructional purposes, and it may not have been selected to delineate or circumscribe the patent rights. It is therefore intended that the scope of the patent rights be limited not by this detailed description, but rather by any claims that issue on an application based hereon. Accordingly, the disclosure of the embodiments is intended to be illustrative, but not limiting, of the scope of the patent rights, which is set forth in the following claims.

What is claimed is:

1. A system for dispensing single serving food items comprising:
one or more cavities, wherein each of the one or more cavities is configured to hold a food item, each cavity having an opening through which the food item may be dispensed and a wall opposite the opening, the wall configured to move toward the opening responsive to force applied to the wall of the cavity;
a support matrix configured to hold each of the one or more cavities at a specified location in the support matrix;
a punch associated with an actuation system, the actuation system configured to align the punch with the cavity at the specified location and actuate the punch to extend into the support matrix and retract out of the support matrix; and
a controller configured to:
receive instructions, the instructions comprising a food item ordered by a user of the system;
determine the specified location of the cavity within the support matrix, the cavity holding the ordered food item; and
transmit instructions to the actuation mechanism, the instructions comprising:
aligning, via the actuation mechanism, the punch with the specified location of the cavity within the support matrix; and
extending the punch into the support matrix at the specified location to compress the wall of the cavity holding the ordered food item, the compression of the wall causing the food item to be dispensed from the opening of the cavity.

2. The system of claim 1, wherein the punch is configured to pull the wall of the cavity to a desired position as the punch is retracted.

3. The system of claim 1, wherein the opening of each of the one or more cavities is coupled to a nozzle, the nozzle configured to prevent dripping or clinging of the food item when the food item is dispensed.

4. The system of claim 3, wherein the nozzle further comprises a blade configured to cut the food item as the food item is dispensed.

5. The system of claim 1 wherein the each of the one or more cavities is an isolated temperature-controlled zone such that each cavity has an internal temperature based on the food item held in the cavity.

6. The system of claim 1, wherein the punch is configured to extend into the support matrix to an indicated depth, the indicated depth included in the instructions and corresponding to an amount of the ordered food item to be dispensed.

7. The system of claim 1, wherein the punch is further configured with sensors to detect characteristics of the food item held by the cavity.

8. A method of dispensing a food item comprising:
receiving instructions, the instructions comprising a food item ordered by a user;
determining a specified location of a cavity within a support matrix, the cavity holding the ordered food item; and
transmitting instructions to an actuation mechanism, the instructions comprising:
aligning, via the actuation mechanism, a punch with the specified location of the cavity within the support matrix; and
extending the punch into the support matrix at the specified location to compress a wall of the cavity holding the ordered food item, the compression of the wall causing the food item to be dispensed from an opening of the cavity.

9. The method of claim 8, further comprising pulling the wall of the cavity to a desired position as the punch is retracted.

10. The method of claim 8, wherein the opening of each of the one or more cavities is coupled to a nozzle, the nozzle configured to prevent dripping or clinging of the food item when the food item is dispensed.

11. The method of claim 10, wherein the nozzle further comprises a blade configured to cut the food item as the food item is dispensed.

12. The method of claim 8, wherein the cavity is an isolated temperature-controlled zone such that each cavity has an internal temperature based on the food item held in the cavity.

13. The method of claim 8, wherein the punch is configured to extend into the support matrix to an indicated depth, the indicated depth included in the instructions and corresponding to an amount of the ordered food item to be dispensed.

14. The method of claim 8, wherein the punch is further configured with sensors to detect characteristics of the food item held by the cavity.

15. A non-transitory computer readable medium comprising stored instructions that when executed by one or more processors, configure the one or more processors to:
receive instructions, the instructions comprising a food item ordered by a user;
determine a specified location of a cavity within a support matrix, the cavity holding the ordered food item; and
transmit instructions to an actuation mechanism, the instructions further comprising instructions that configures the one or more processors to:
align, via the actuation mechanism, a punch with the specified location of the cavity within the support matrix; and
extend the punch into the support matrix at the specified location to compress a wall of the cavity holding the ordered food item, the compression of the wall causing the food item to be dispensed from an opening of the cavity.

16. The non-transitory computer readable medium of claim 15, wherein the one or more processors are further configured to transmit instructions to the actuation mechanism comprising pulling the wall of the cavity to a desired position as the punch is retracted.

17. The non-transitory computer readable medium of claim 15, wherein the opening of each of the one or more cavities is coupled to a nozzle, the nozzle configured to prevent dripping or clinging of the food item when the food item is dispensed.

18. The non-transitory computer readable medium of claim 15, wherein the cavity is an isolated temperature-controlled zone such that each cavity has an internal temperature based on the food item held in the cavity.

19. The non-transitory computer readable medium of claim 15, wherein the punch is configured to extend into the support matrix to an indicated depth, the indicated depth included in the instructions and corresponding to an amount of the ordered food item to be dispensed.

20. The non-transitory computer readable medium of claim 15, wherein the punch is further configured with sensors to detect characteristics of the food item held by the cavity.
